(19) United States
(12) Patent Application Publication
(10) Pub. No.: US 2013/0221689 A1
(43) Pub. Date: Aug. 29, 2013

(54) DEVICE FOR SECURING THE LOCKED POSITION OF A VEHICLE DOOR CATCH

(71) Applicant: FORD GLOBAL TECHNOLOGIES, LLC, (US)

(72) Inventor: Thomas Kreuz, Mechernich (DE)

(73) Assignee: FORD GLOBAL TECHNOLOGIES, LLC, Dearborn, MI (US)

(21) Appl. No.: 13/758,456

(22) Filed: Feb. 4, 2013

(30) Foreign Application Priority Data
Feb. 27, 2012 (DE) 102012202891.9

(51) Int. Cl. E05B 65/12

(52) U.S. Cl. CPC E05B 85/13
USPC 292/336.3

(57) ABSTRACT

A device for securing the locked position of a car door catch, with an outer part having a shaft and a securing knob which is arranged movably in the shaft and is connected with an actuator element for securing the door. To connect the actuator shaft with the securing knob, a converter element is provided which element transforms a rotary motion of the actuator shaft into a linear motion of the securing knob.

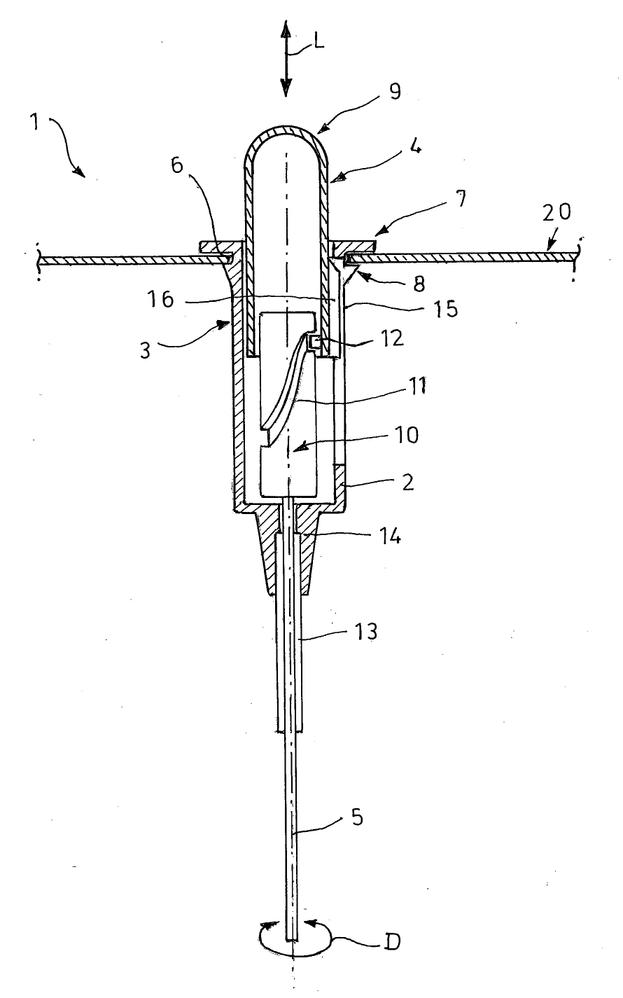

### FIELD OF THE INVENTION

The present invention generally relates to a device for securing the locked position of a vehicle door catch, with an outer part having a shaft and a securing knob which is arranged movably in the shaft and is connected with an actuating element for securing the door.

### BACKGROUND OF THE INVENTION

DE 1 653 962 A discloses a device for securing the locked position of a car door catch, essentially having a securing rod which is connected with an angle lever connected with the catch mechanism inside the door, and which protrudes freely through an opening provided in the lower window frame with a push-fit actuator knob of elastic material, and which can be brought into the securing position by pressure in the axial direction. The securing rod is flexible in the pressure direction against the angle lever via a pretensioned spring, but in contrast is arranged fixed in the return direction.

EP 0 198 210 A2 discloses an actuator device intended for a motor vehicle for securing the door on the inside, with an outer part having a shaft and a securing knob which is arranged movably in the shaft and is connected with an actuating shaft for securing the door. To connect the actuating shaft with the securing knob, a yoke part is provided on the securing knob including a base body and an engagement piece which can be inserted therein. The yoke part is adapted for two-stage locking of the engagement piece in a standby position in which the yoke piece can be moved over the actuator shaft, and in a securing position in which the actuator shaft is firmly held in the yoke part.

U.S. Pat. No. 7,108,302 B2 discloses a similar device in which the securing knob transforms into a rod which in turn is connected to an angle lever by means of a Bowden cable for actuation via the door catch.

One problem with these devices is that they all require an angle lever which can be actuated via the door catch to activate or move the securing knob, in order to achieve the necessary linear motion of the securing knob. It would therefore be desirable to provide a device for securing the locked position of a car door catch which does not require an angle lever.

### SUMMARY OF THE INVENTION

According to one aspect of the present invention, a device for securing the locked position of a vehicle door catch is provided. The device includes an outer part comprising a shaft and a securing knob arranged movably within the shaft, and an actuator shaft for securing the door. The device also includes a converter element operatively coupled to the actuator shaft and the securing knob to transform rotary motion of the actuator shaft into linear motion of the securing knob.

According to another aspect of the present invention, a device for securing the locked position of a vehicle door catch is provided. The device includes an outer part assembled to a door panel and including a shaft and a securing knob arranged axially moveable within the shaft, and an actuator shaft rotationally moveable for securing the door. The device also includes a converter element operatively coupled to the actuator shaft and the securing knob to transform rotary motion of the actuator shaft into linear motion of the securing knob.

These and other aspects, objects, and features of the present invention will be understood and appreciated by those skilled in the art upon studying the following specification, claims, and appended drawings.

### BRIEF DESCRIPTION OF THE DRAWINGS

In the drawing:

The FIGURE shows a diagrammatic longitudinal section through a device for securing the locked position of a car door catch, which device can be activated by means of a rotary movement.

### DETAILED DESCRIPTION OF THE PREFERRED EMBODIMENTS

The FIGURE designates as a whole with reference identifier 1 as the device for securing the locked position of a vehicle door catch such as a latch or other locking mechanism on a door panel 20. The device 1 includes an outer part 2 with a shaft 3 and a locking button or securing knob 4 which is arranged movably in the shaft 3 and is connected with a flexible actuating shaft 5 for securing the door of a vehicle such as a car in a locked position. The outer part 2 is inserted with engagement in a recess 6 in the door panel 2 with a peripheral collar 7 and a spaced locking collar 8. The securing knob 4 has a rounded cap 9 that extends outward from the door panel 2.

To connect the flexible actuator shaft 5 with the securing knob 4, a converter element 10 is provided which converts a rotary motion D of the actuator shaft 5 into a linear motion L of the securing knob 4. For this, the converter element 10 includes a helical sliding block guide 11 running peripherally on the outside, in which the securing knob 4 engages with a cam 12. In the present description of the device, the term “helical” means in a helix form, i.e., a screw-like structure.

The converter element 10 is connected rotationally fixed with the actuator shaft 5. The converter element 10 is arranged axially immobile but rotationally mobile in the outer part 2. The actuator shaft 5 is mounted rotationally mobile in the indicated Bowden cable sheath 13. The Bowden cable sheath 13 is attached to the outer part 2 at a corresponding shoulder 14.

The securing knob 4 is arranged rotationally fixed but axially mobile (direction L) in the outer part 2 or shaft 3 by means of a rib 16 engaging in a recess 15, and is guided at the same time.

The securing knob 4 is formed as a hollow cylinder, on the inner periphery of which is arranged the cam 12, and the cylindrical converter element 10 has a smaller diameter than the inner diameter of the hollow cylinder so that the securing knob 4 “slides” over the converter element 10 when lowered.

The device 1 may be operated by moving the securing knob 4 downward to lock the vehicle catch or door lock. In doing so, the securing knob 4 moving linearly downward will cause a rotational movement in the converter element 10 which, in turn, will cause the actuator shaft 5 to rotate about the rotary motion D which, in turn, may actuate a catch or latch mechanism to the lock position to lock the door. Contrarily, rotation of the latch mechanism in the opposite direction causes the actuator shaft 5 to rotate which, in turn, will convert rotation at the converter element 10 to linear movement of the securing knob 4 to move to the upward position. It should be appreciated that the movement of the securing knob 4 and locking mechanism may be achieved manually or may include the use of a powered lock.

It has been found that by use of the actuating element as an actuator shaft and of a converter element to connect the actuator shaft with the securing knob, which converter element can convert a rotary motion of the actuator shaft into a linear motion of the securing knob, the angle lever can be omitted.

This is advantageous as the normal door catches practically always provide a rotation movement which can simply be used also for the movement of the securing knob. This rotation movement of the door catch is transferred to the securing knob via the actuator shaft and converter element. The actuator shaft is preferably mounted in a Bowden cable sheath.

If the converter element includes a helical sliding block guide running peripherally on the outside, in which the securing knob engages with a cam, the conversion of the rotary motion into the linear motion can be achieved particularly simply. Also, the parts can be produced as injection moldings.

It is useful if the converter element is connected rotationally fixed with the actuator shaft. In addition, the converter element can be arranged axially immobile in the outer part. This can be achieved e.g., by a fixed connection with the actuator shaft and its fixing in the axial direction by a thickened peripheral region which stops against the outer part.

The securing knob is arranged in the outer part rotationally fixed but axially mobile in the outer part by means of a rib engaging in a recess, so as to ensure that the entire rotary motion is converted into a linear motion. The recess can be formed as a slot and the rib dimensioned accordingly. It is evident that a simpler lug and recess can be used, but these generally do not provide the guide function achieved simultaneously.

In a particular embodiment, the securing knob is formed as a hollow cylinder, on the inner periphery of which is arranged the cam, and the cylindrical converter element has a smaller diameter than the inner diameter of the hollow cylinder. Thus, the parts can engage in each other and construction space can be saved.

It will be understood by one having ordinary skill in the art that construction of the described invention and other components is not limited to any specific material. Other exemplary embodiments of the invention disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the invention as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the device may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present invention. The exemplary structures and processes disclosed herein are for illustrative purposes and are not to be construed as limiting.

It is also to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A device for securing the locked position of a vehicle door catch comprising:
an outer part comprising a shaft and a securing knob arranged movably within the shaft;
an actuator shaft for securing the door; and
a converter element operatively coupled to the actuator shaft and the securing knob to transform rotary motion of the actuator shaft into linear motion of the securing knob.

2. The device as claimed in claim 1, wherein the converter element comprises a helical sliding block guide running peripherally on the outside, in which the securing knob engages with a cam.

3. The device as claimed in claim 2, wherein the converter element is connected rotationally fixed with the actuator shaft.

4. The device as claimed in claim 3, wherein the converter element is arranged axially immobile in the outer part.

5. The device as claimed in claim 4, wherein the securing knob is arranged rotationally fixed and axially mobile in the outer part by means of a rib engaging in a recess.

6. The device as claimed in claim 2, wherein the securing knob is formed as a hollow cylinder, on the inner periphery of which is arranged the cam, and the cylindrical converter element has a smaller diameter than the inner diameter of the hollow cylinder.

7. The device as claimed in claim 1, wherein the converter element is connected rotationally fixed with the actuator shaft and is arranged axially immobile in the outer part.

8. The device as claimed in claim 1, wherein the securing knob is arranged rotationally fixed and axially mobile in the outer part by means of a rib engaging in a recess.

9. The device as claimed in claim 1, wherein the outer part is assembled to a door panel such that the securing knob extends through the door panel.

10. A device for securing the locked position of a vehicle door catch comprising:
an outer part assembled to a door panel and comprising a shaft and a securing knob arranged axially moveable within the shaft;
an actuator shaft rotationally moveable for securing the door; and
a converter element operatively coupled to the actuator shaft and the securing knob to transform rotary motion of the actuator shaft into linear motion of the securing knob.

11. The device as claimed in claim 10, wherein the converter element comprises a helical sliding block guide running peripherally on the outside, in which the securing knob engages with a cam.

12. The device as claimed in claim 11, wherein the converter element is connected rotationally fixed with the actuator shaft.

13. The device as claimed in claim 12, wherein the converter element is arranged axially immobile in the outer part.

14. The device as claimed in claim 13, wherein the securing knob is arranged rotationally fixed and axially mobile in the outer part by means of a rib engaging in a recess.

15. The device as claimed in claim 11, wherein the securing knob is formed as a hollow cylinder, on the inner periphery of which is arranged the cam, and the cylindrical converter element has a smaller diameter than the inner diameter of the hollow cylinder.

16. The device as claimed in claim 10, wherein the converter element is connected rotationally fixed with the actuator shaft and is arranged axially immobile in the outer part.

17. The device as claimed in claim 10, wherein the securing knob is arranged rotationally fixed and axially mobile in the outer part by means of a rib engaging in a recess.
